(19) United States
(12) Patent Application Publication
(10) Pub. No.: US 2011/0193262 A1
(43) Pub. Date: Aug. 11, 2011

(54) Method for forming a microstructure on a polymeric substrate

(75) Inventors: Chien-Chong Hong, Hsinchu County (TW); Pin Huang, Yunlin County (TW); Jiann Shieh, Hsinchu County (TW)

(73) Assignee: NATIONAL TSING HUA UNIVERSIT

(21) Appl. No.: 12/924,945

(22) Filed: Oct. 7, 2010

(30) Foreign Application Priority Data
Feb. 11, 2010 (TW) 099104381

(51) Int. Cl. B29C 59/02

(52) U.S. Cl. 264/293

(57) ABSTRACT

A method for forming a microstructure on a polymeric substrate includes: providing a master mold formed with a micro-feature thereon, the micro-feature having a base portion and a plurality of protrusion portions protruding from the base portion, each of the protrusion portions having a tapered anisotropic shape, including a free end distal from the base portion, and being spaced apart from an adjacent one of the protrusion portions, a distance between the free ends of two adjacent ones of the protrusion portions being not greater than 40 nm; and impressing the free end of each of the protrusion portions of the micro-feature into the polymeric substrate at an elevated temperature T₁, the polymeric substrate having a pyrolysis temperature Tₚ greater than the elevated temperature T₁.

### CROSS-REFERENCE TO RELATED APPLICATION

This application claims priority of Taiwanese application no. 099104381, filed on Feb. 11, 2010.

### BACKGROUND OF THE INVENTION

1. Field of the Invention

This invention relates to a method for forming a microstructure on a polymeric substrate, more particularly to a method for forming a microstructure on a polymeric substrate at an elevated temperature using a master mold formed with a plurality of nano-sized protrusion portions.

2. Description of the Related Art

A microstructure, especially a nano-scale microstructure having a high aspect ratio is widely used in biological, mechanical, and micro-electro mechanical fields. Nanoimprintlithography techniques, such as hot embossing nanoimprintlithography (HE-NIL), are commonly used to form the microstructure by transferring a microstructure pattern from a master mold onto a polymeric substrate.

However, making a nano-sized microstructure which has a high aspect ratio using a master mold having a nano-sized microfeature is relatively difficult. The reasons reside in that the flowability of the polymeric substrate with high molecule weight in the nano-sized microfeature of the master mold cannot be predicted, i.e., the microstructure pattern might not be successfully transferred from the master mold onto the polymeric substrate in nano-sized scale. Moreover, in general, a master mold is used to form a single pattern of microstructure, e.g., a master mold with protrusion features is used to form an indent microstructure on a substrate. As a consequence, forming different microstructures with different aspect ratios on the polymeric substrate requires the use of different master molds, which results in an increase in production costs and an increase in production time.

### SUMMARY OF THE INVENTION

Therefore, the object of the present invention is to provide a method for forming a microstructure on a polymeric substrate that can overcome the aforesaid drawbacks of the prior art.

According to this invention, a method for forming a microstructure on a polymeric substrate comprises: providing a master mold formed with a micro-feature thereon, the micro-feature having a base portion and a plurality of protrusion portions protruding from the base portion, each of the protrusion portions having a tapered anisotropic shape, including a free end distal from the base portion, and being spaced apart from an adjacent one of the protrusion portions, a distance between the free ends of two adjacent ones of the protrusion portions being not greater than 40 nm; and impressing the free end of each of the protrusion portions of the micro-feature into the polymeric substrate at an elevated temperature T₁, the polymeric substrate having a pyrolysis temperature Tₚ greater than the elevated temperature T₁.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic view showing a master mold used in the preferred embodiment of a method for forming a microstructure on a polymeric substrate according to this invention, the master mold being formed with protrusion portions, each of the protrusion portions including a free end;

FIG. 2 is a schematic view to illustrate an impressing step for the first preferred embodiment of a method for forming a microstructure on a polymeric substrate according to this invention;

FIG. 3 is a top view illustrating the microstructure made using the first preferred embodiment of the method according to this invention;

FIG. 4 is a schematic view to illustrate an impressing step for the second preferred embodiment of the method for forming the microstructure on the polymeric substrate according to this invention;

FIG. 5 is a sectional view taken along line V-V of FIG. 4;

FIG. 6 is a schematic view to illustrate an impressing step for the third preferred embodiment of the method for forming the microstructure on the polymeric substrate according to this invention;

FIG. 7 is a sectional view taken along line VII-VII of FIG. 6;

FIG. 8 is a schematic view to illustrate an impressing step for the fourth preferred embodiment of the method for forming the microstructure on the polymeric substrate according to this invention;

FIG. 9 is a sectional view taken along line IX-IX of FIG. 8;

FIG. 10A is a scanning electron microscope (SEM) image to illustrate a master mold used in the examples of this invention, the master mold being made from a silicon (Si) substrate and being formed with a plurality of nanopins by hydrogen plasma etching techniques;

FIG. 10B is an enlarged SEM image of FIG. 10A;

FIG. 11 is a SEM image to illustrate the microstructure of Example 1 (E1), the microstructure being formed on a cyclic olefin copolymer (COC) substrate using the first preferred embodiment of the method according to this invention;

FIG. 12 is a SEM image to illustrate the microstructure of Example 2 (E2), the microstructure being formed on a cyclic olefin copolymer (COC) substrate using the second preferred embodiment of the method according to this invention;

FIG. 13 is a SEM image to illustrate a microstructure of Example 3 (E3), the microstructure being formed on a cyclic olefin copolymer (COC) substrate using the third preferred embodiment of the method according to this invention; and

FIG. 14 is a SEM image to illustrate a microstructure of Example 4 (E4), the microstructure being formed on a cyclic olefin copolymer (COC) substrate using the fourth preferred embodiment of the method according to this invention.

### DETAILED DESCRIPTION OF THE PREFERRED EMBODIMENTS

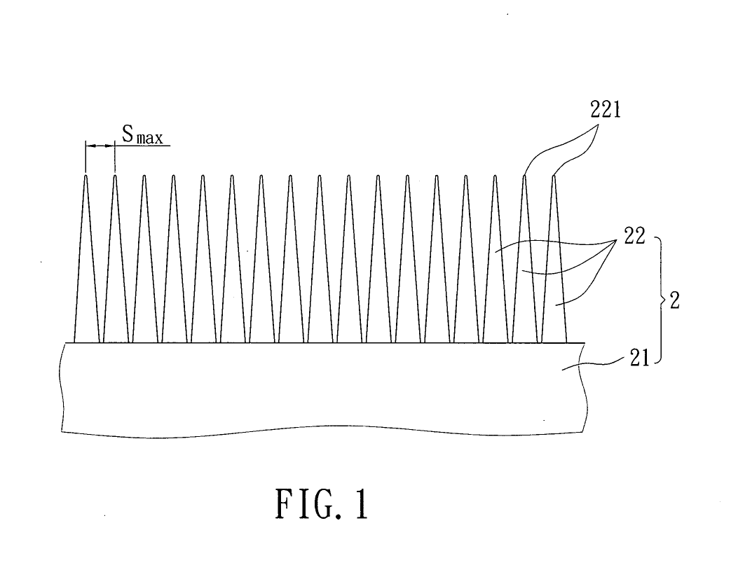

A method for forming a microstructure on a polymeric substrate according to the present invention includes: providing a master mold 2 formed with a micro-feature thereon (see FIG. 1), the micro-feature having a base portion 21 and a plurality of protrusion portions 22 protruding from the base portion 21, each of the protrusion portions 22 having a tapered anisotropic shape, including a free end 221 distal from the base portion 21, and being spaced apart from an adjacent one of the protrusion portions, a distance Sₘₐₓ between the free ends 221 of two adjacent ones of the protrusion portions 22 being not greater than 40 nm; and impressing the free end 221 of each of the protrusion portions 22 of the micro-feature into the polymeric substrate at an elevated temperature T₁, the polymeric substrate having a pyrolysis temperature Tₚ greater than the elevated temperature T₁.

Each of the protrusion portions 22 of the micro-feature has a size in nano scale. In the examples of this invention, each protrusion portion 22 has a diameter of about 20 nm at one-half of the height thereof.

Preferably, the polymeric substrate has a glass transition temperature T_{g} and a heat distortion temperature T₂, where T₂≦T₁<Tₚ.

Preferably, the method further includes, after the impressing step, removing the master mold 2 from the polymeric substrate under an elevated temperature T₃, the elevated temperature T₃ being less than the glass transition temperature T_{g} of the polymeric substrate. More preferably, the elevated temperature T₃ is lower than the heat distortion temperature T₂ of the polymeric substrate.

Preferably, the method further includes, before the impressing step, forming an anti-sticking layer (not shown), which has a surface energy less than that of the micro-feature, on a surface of each of the protrusion portions 22 of the micro-feature so as to prevent adjacent ones of the protrusion portions 22 from sticking to each other and to facilitate removal of the master mold 2 from the polymeric substrate in the removing step. Preferably, the anti-sticking layer is made from octadecyl-trichlorosilane (OTS) or 1H,1H, 2H,2H-perfluorooctyl trichlorosilane (FOTS).

Preferably, each of the protrusion portions 22 includes a nanopin.

Preferably, each of the protrusion portions 22 has an aspect ratio greater than 1 and less than 14. In the present invention, the aspect ratio of each protrusion portion 22 is defined as H/D, where H and D respectively represent the height of the protrusion portion 22 and the diameter of the protrusion portion 22 at one-half of the height thereof.

During the impressing step, the polymeric substrate is subjected to a pressing pressure and heat (i.e., at the elevated temperature T₁). Therefore, mechanical strength and viscosity of the polymeric substrate should be considered. The mechanical strength is determined by Young's modulus and is relevant to the stability of the microstructure formed on the polymeric substrate. Viscosity determines the flowability of the polymeric substrate at a visco-elastic state during the impressing step, and is relevant to the structural integrity and time required for the impressing step. Preferably, the polymeric substrate has a Young's modulus not less than 2 GPa and a melt flow rate (MFR) ranging from 2 g/10 mins to 50 g/10 mins. More preferably, the polymeric substrate is made from polycarbonate (PC), polymethylmethacrylate (PMMA), cyclic olefin copolymer (COC), epoxy resin, polystyrene (PS), or polyvinylchloride(PVC). In the embodiments and the examples of this invention, the polymeric substrate is made from cyclic olefin copolymer (COC) having a glass transition temperature T_{g} of 158° C. The preferred embodiments of the method for forming microstructures having different aspect ratios and patterns using the aforesaid master mold 2 are illustrated below.

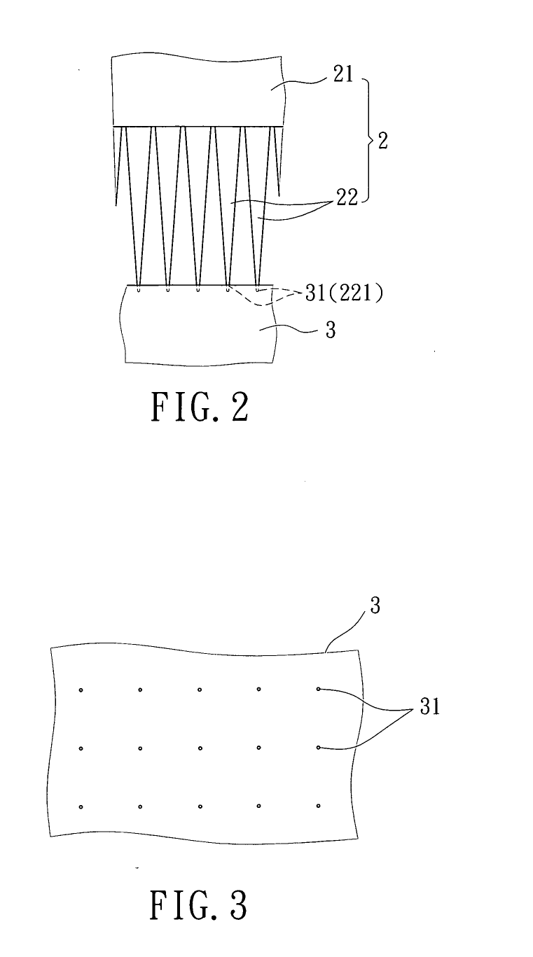

FIGS. 2 and 3 show the impressing step and the microstructure thus formed in the first preferred embodiment. In this embodiment, the impressing step was conducted at an elevated temperature T₁ close to T_{g}−40° C. (nearly 120° C.). Since the elevated temperature T₁ is less than the glass transition temperature T_{g} of the polymeric substrate 3, the polymeric substrate 3 still exhibits solid property and has no flowability. Thus, in this embodiment, the microstructure is made mainly through the pressing pressure, and is in the form of nanpores 31 having a low aspect ratio less than 2 (see FIG. 3). The microstructure formed in this embodiment can be used as a biosensor or an optical diffraction grating.

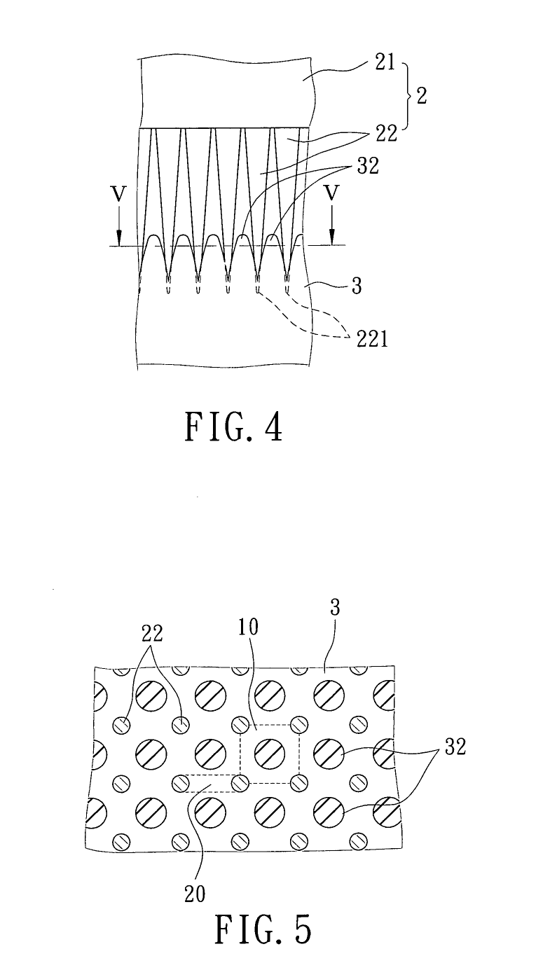

FIGS. 4 and 5 illustrate the impressing step and the microstructure thus formed in the second preferred embodiment. The second preferred embodiment differs from the first preferred embodiment in that the impressing step of the second preferred embodiment was conducted at an elevated temperature T₁ close to and slightly greater than the glass transition temperature T_{g} of the polymeric substrate 3. Therefore, the polymeric substrate 3 begins transferring from solid state to visco-elastic state and exhibits flowability. Referring to FIG. 5, a first space 10 of the master mold 2 surrounded by four adjacent protrusion portions 22 is greater than a second space 20 between two adjacent protrusion portions 22. The larger the space, the lower will be the flow resistance. As a consequence, the polymeric substrate 3 at the visco-elastic state would firstly flow into the first space 10 where the viscous substrate encounters lower flow resistance. Moreover, since each of the protrusion portions 22 tapers in shape, i.e., the spaces 10, 20 among the protrusion portions 22 get smaller in a direction from the free end 221 toward the base portion 21, the flow resistance will become greater as the viscous substrate flows into the space 10 toward the base portion 21. When the viscous substrate flowing into the first space 10 and toward the base portion 21 encounters sufficient high flow resistance, the flow of the viscous substrate will stop. After removal the master mold 2, the microstructure thus formed on the polymeric substrate 3 in the second preferred embodiment includes nanopins 32 having a low aspect ratio ranging from 2 to 6 (see FIG. 4). The microstructure formed in this embodiment can be used as an optical diffraction grating.

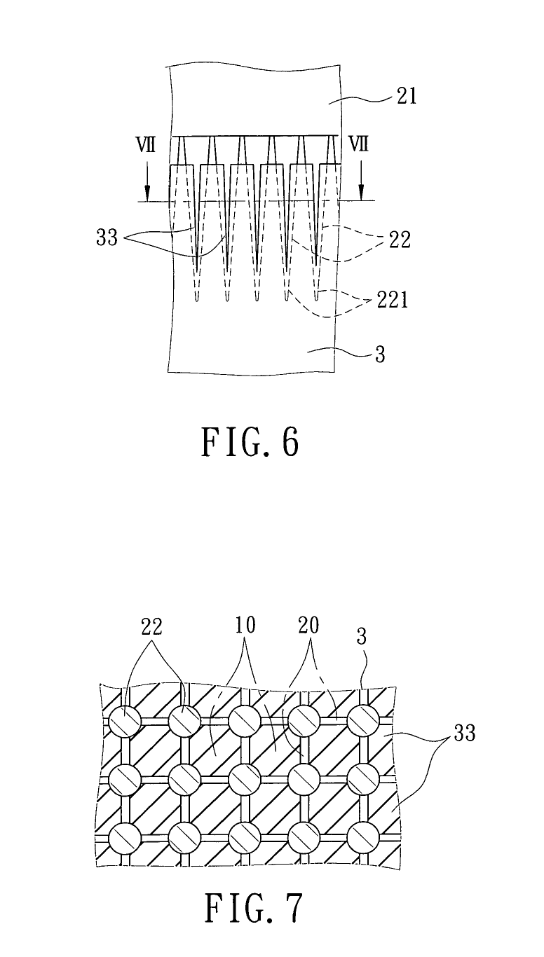

FIGS. 6 and 7 illustrate the impressing step and the microstructure thus formed in the third preferred embodiment. The third preferred embodiment differs from the second embodiment in that the impressing step of the third preferred embodiment was conducted at an elevated temperature T₁ close to T_{g}+20° C.

The polymeric substrate 3 under such elevated temperature T₁ (i.e., close to T_{g}+20° C.) has a viscosity lower than that of the polymeric substrate 3 in the second preferred embodiment such that the viscous substrate not only flows into the first space 10 but also into the second space 20, and the depth where the viscous substrate flows into the spaces 10, 20 toward the base portion 21 is greater than that of the first preferred embodiment. However, because of flow resistance, the viscous substrate can not flow into the relatively small spaces among the protrusion portions 22 adjacent to the base portion 21. The microstructure thus formed on the polymeric substrate 3 in the third preferred embodiment includes nanopins 33 having a high aspect ratio greater than 6 (see FIG. 6).

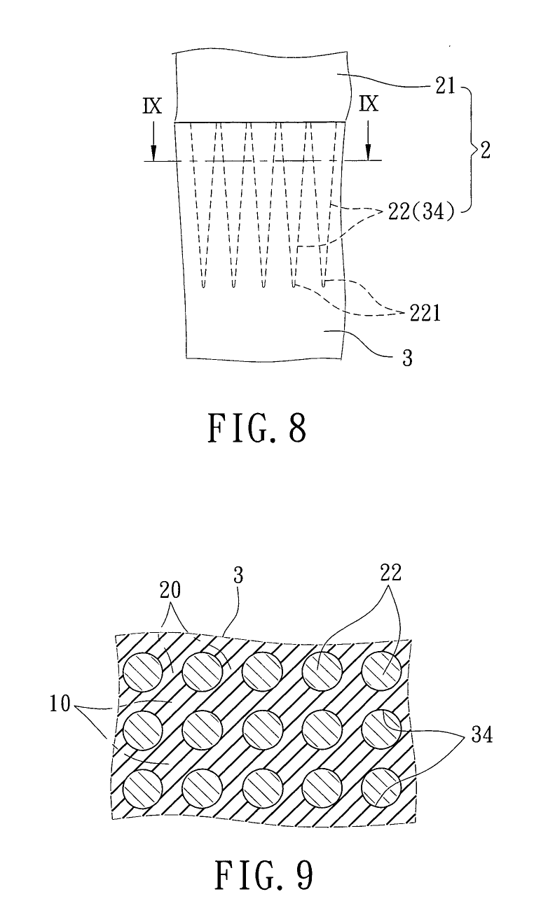

FIGS. 8 and 9 illustrate the impressing step and the microstructure thus formed in the fourth preferred embodiment. The fourth preferred embodiment differs from the third embodiment in that the impressing operation of the fourth preferred embodiment was conducted at an elevated temperature T₁ greater than T_{g}+30° C.

In this embodiment, the polymeric substrate 3 at such elevated temperature T₁ has a superior flowability, i.e., extremely low viscosity, and the flow resistance for the polymeric substrate 3 is extremely low. As a consequence, the viscous substrate could fill up all of the spaces among the protrusion portions 22, and the microstructure thus formed on the polymeric substrate 3 in the fourth preferred embodiment includes nanopores 34 having a high aspect ratio greater than 10 (see FIG. 9).

The applicant surprisingly founds that, by controlling the elevated temperature T₁ of the impressing step, the master mold 2 having the nano-sized micro-feature (i.e., the distance Sₘₐₓ between the free ends 221 of two adjacent protrusion portions 22 to be not greater than 40 nm) can be successfully used to form different microstructures on the polymeric substrate 3.

The following examples are provided to illustrate the merits of the preferred embodiments of the invention, and should not be construed as limiting the scope of the invention.

### EXAMPLES

### Example 1 (E1)>

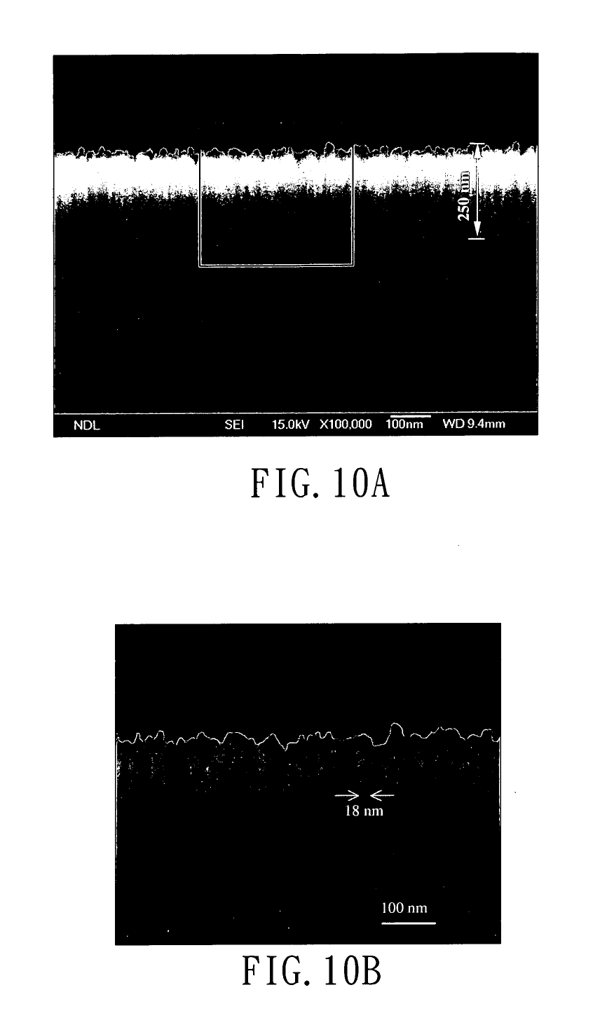

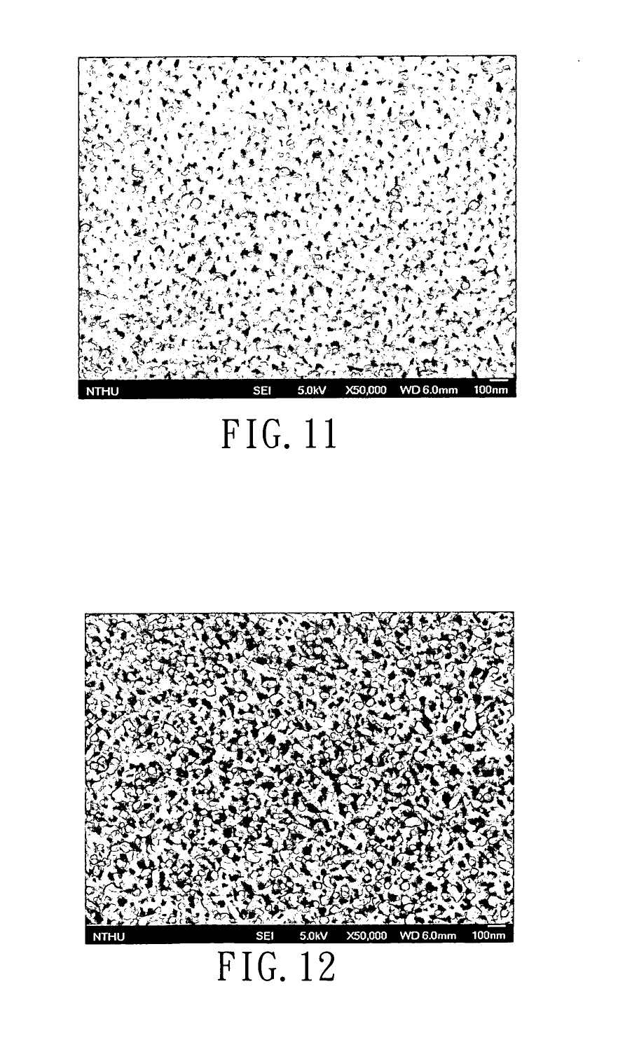

A microstructure formed on a polymeric substrate for Example 1 (E1) was prepared based on the method of the aforesaid first preferred embodiment. A processing chamber was cleaned using CF₄ and O₂ plasma, followed by controlling the pressure in the cleaned chamber at 5×10⁻⁵ torr. A Si substrate was placed in the cleaned chamber, and was then subjected to a hydrogen plasma etching process (see Electrochemical and Solid-State Letters, Vol. 8, No. 10, pp. C131 (2005)) so as to form a master mold formed with nanopins on the Si substrate, each of the nanopins having a height of about 250 nm and a diameter of about 18 nm at one-half of the height thereof (see FIGS. 10A and 10B). An anti-sticking layer, which is made from octadecyl-trichlorosilane (OTS), was formed on a surface of each of the nanopins by chemical vapor deposition (CVD) techniques at 250° C. for 2 hours. The master mold formed with the anti-sticking layer thereon and a polymeric substrate made from cyclic olefin copolymer (TOPAS® 6015) and having a glass transition temperature T_{g} of 158° C., a heat distortion temperature T₂ of 110° C., and a thickness of 5.3 mm, were respectively disposed on an upper chuck and a lower chuck of a hot pressing machine, the upper and lower chucks having an initial temperature of 120° C. An initial pressure of 1 Kgf/cm² was initially applied to the master mold so as to transfer the initial pressure to the cyclic olefin copolymer (COC) substrate for 5minutes and to allow heat uniformly transmitting to the master mold and the polymeric substrate followed by increase of the pressure to 5 Kgf/cm² and maintenance of the temperature at an elevated temperature T₁ of 120° C. The cyclic olefin copolymer (COC) substrate was subjected to the impressing step under such conditions for 15 minutes. The COC substrate and the master mold were slowly cooled down to an elevated temperature T₃ lower than 110° C. (i.e., the heat distortion temperature T₂ of the COC substrate), and then were placed on a hot plate, followed by removal of the master mold from the COC substrate. The microstructure of Example 1 (E1) thus formed on the COC substrate includes nanopores having a low aspect ratio less than 2 (see FIG. 11).

### Example 2 (E2)

A microstructure formed on a polymeric substrate for Example 2 (E2) was prepared based on the method of the second preferred embodiment. The procedures and operating conditions for preparing the microstructure on the polymeric substrate were similar to those of Example 1 (E1), except that the impressing step was conducted at an elevated temperature T₁ of 160° C. The microstructure of Example 2 (E2) thus formed on a cyclic olefin copolymer (COC) substrate includes nanopins having a low aspect ratio not greater than 6 (see FIG. 12).

### Example 3 (E3)

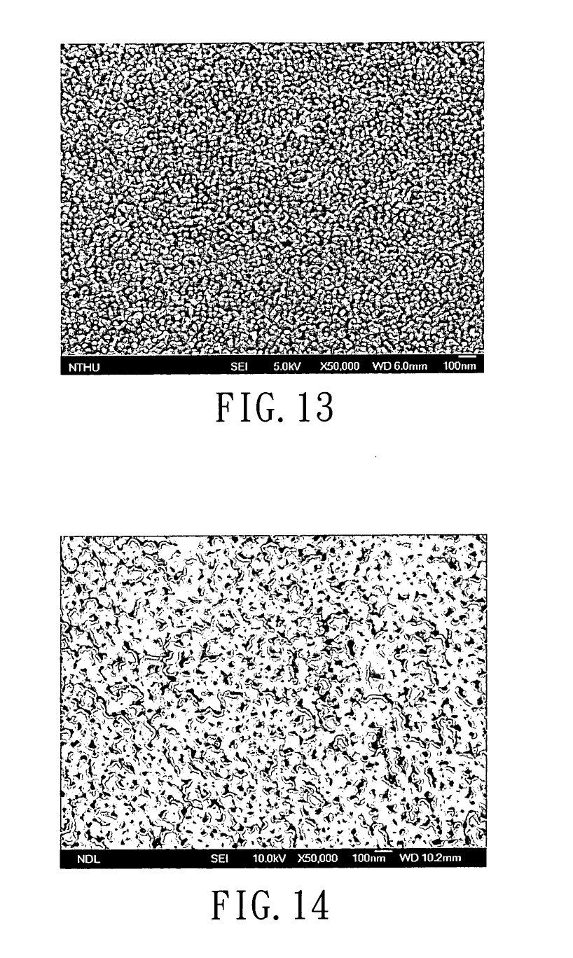

A microstructure formed on a polymeric substrate for Example 3 (E3) was prepared based on the method of the third preferred embodiment. The procedures and operating conditions for preparing the microstructure on the polymeric substrate were similar to those of Example 1 (E1), except that the impressing step was conducted at an elevated temperature T₁ of 180° C. The microstructure of Example 3 (E3) thus formed on a cyclic olefin copolymer (COC) substrate includes nanopins having a high aspect ratio greater than 6 (see FIG. 13).

### Example 4 (E4)

A microstructure formed on a polymeric substrate for Example 4 (E4) was prepared based on the method of the fourth preferred embodiment. The procedures and operating conditions for preparing the microstructure on the polymeric substrate were similar to those of Example 1 (E1), except that the impressing step was conducted at an elevated temperature T₁ of 220° C. The microstructure of Example 4 (E4) thus formed on a cyclic olefin copolymer (COC) substrate includes nanopores having a high aspect ratio greater than 10 (see FIG. 14).

In conclusion, by using the master mold in which the distance Sₘₐₓ between the free ends 221 of two adjacent protrusion portions 22 to be not greater than 40 nm, and by controlling the elevated temperature of the impressing step, different microstructures may be formed using such single master mold, thereby reducing the production costs and time.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for forming a microstructure on a polymeric substrate, comprising:
providing a master mold formed with a micro-feature thereon, the micro-feature having a base portion and a plurality of protrusion portions protruding from the base portion, each of the protrusion portions having a tapered anisotropic shape, including a free end distal from the base portion, and being spaced apart from an adjacent one of the protrusion portions, a distance between the free ends of two adjacent ones of the protrusion portions being not greater than 40 nm; and
impressing the free end of each of the protrusion portions of the micro-feature into the polymeric substrate at an elevated temperature T₁, the polymeric substrate having a pyrolysis temperature Tₚ greater than the elevated temperature T₁.

2. The method of claim 1, wherein the polymeric substrate has a heat distortion temperature T₂, where T₂≦T₁<Tₚ.

3. The method of claim 2, wherein each of the protrusion portions includes a nanopin.

4. The method of claim 3, wherein the polymeric substrate is a cyclic olefin copolymer (COC) substrate.

5. The method of claim 4, wherein the polymeric substrate has a glass transition temperature T_{g}, and the impressing step is conducted at the elevated temperature T₁ close to T_{g}−40, the microstructure being nanopores having a low aspect ratio less than 2.

6. The method of claim 4, wherein the polymeric substrate has a glass transition temperature T_{g}, and the impressing step is conducted at the elevated temperature T₁ close to T_{g}, the microstructure being nanopins having a low aspect ratio ranging from 2 to 6.

7. The method of claim 4, wherein the polymeric substrate has a glass transition temperature T_{g}, and the impressing step is conducted at the elevated temperature T₁ close to T_{g}+20, the microstructure being nanopins having a high aspect ratio greater than 6.

8. The method of claim 4, wherein the polymeric substrate has a glass transition temperature T_{g}, and the impressing step is conducted at the elevated temperature T₁ close to T_{g}+30, the microstructure being nanopores having a high aspect ratio greater than 10.

9. The method of claim 1, further comprising, after the impressing step, removing the master mold from the polymeric substrate under an elevated temperature T₃, the temperature T₃ being less than a glass transition temperature T_{g} of the polymeric substrate.

10. The method of claim 1, further comprising, before the impressing step, forming an anti-sticking layer, which has a surface energy less than that of the micro-feature, on a surface of each of the protrusion portions of the micro-feature.

11. The method of claim 1, wherein each of the protrusion portions has an aspect ratio greater than 1 and less than 14.
